(19) United States
(12) Patent Application Publication
(10) Pub. No.: US 2003/0214779 A1
(43) Pub. Date: Nov. 20, 2003

(54) Portable network server

(76) Inventor: Theodore J. Socolofsky, Naperville, IL (US)

Correspondence Address: BRINKS HOFER GILSON & LIONE, P.O. Box 10395, Chicago, IL, 60610, US

(21) Appl. No.: 10/145,067

(22) Filed: May 14, 2002

(51) Int. Cl. G06F 1/16

(52) U.S. Cl. 361/683

(57) ABSTRACT

In one aspect of the invention, a network server is provided. The server includes a computer configured to host a web site for sharing images posted to the web site across a network. The server also includes a housing having a first cover, a second cover, and a spine. The spine connects the first and second covers in the manner of a book. The computer is mounted to the housing, for example at one or more surfaces of the covers or the spine, to provide the visual appearance of a book for the server.

### FIELD OF THE INVENTION

The present invention relates generally to a portable device for storing, transporting, and sharing multimedia information over a computer network. In particular, it relates to an easy-to-use multimedia network server that provides the portability, familiarity, and visual appearance of a book, more particularly, a photo album or binder.

### BACKGROUND

Consumer electronic devices for capturing, creating, or editing multimedia content, including digital cameras, scanners and home computers, are well known. The convenience, increasing affordability, and evolving performance quality of these devices has led to a growing acceptance of multimedia as a means of communicating information, including text, graphics, video, animation, and sound.

Devices for sharing multimedia content directly with others are well known. For example, multimedia can be stored and displayed on a home personal computer (PC) using suitable software programs. One of the disadvantages of such a system is that individuals must come to the home PC to view the images residing thereon because these computers are generally heavy and bulky and are not easily transportable. Alternatively, multimedia content can be displayed on a portable computer, commonly referred to as a laptop or notebook computer. In addition, digital content representative of text and images contained in a printed book can reside and be displayed on an electronic book. A disadvantage of these systems is that the portable computer or electronic book must travel to the intended viewing audience. Moreover, screens for these devices are often limited in size and cannot show digital images to the best advantage. Electronic books are further disadvantaged by the limited type of multimedia content format that can be displayed.

It is also known that a computer can be connected to a network of computers, including a local area network (LAN) or the worldwide network of computers known as the Internet, to allow multimedia content stored thereon to be shared with remote users. Additionally, the worldwide web allows for graphical web pages to be programmed and transmitted over the Internet. For example, commercial web sites that offer a user the ability to upload and store multimedia content on a remote server away from the user are known. These web sites also allow this multimedia content to be shared with other users accessing the Internet at different locations. Among the disadvantages of a commercial web site is the limited space available to each user, the lack of privacy, the inability to support individual design enhancements, and limited security options.

Alternatively, it is known to set up a local web server using a home PC or a laptop for sharing digital content via a website. However, such a system is costly, difficult, and time-consuming to program, and requires specialized expertise to administer. It is further known to utilize a dedicated, Internet-ready computer, such as the Servio Personal Server from Memora Corp., as a web server appliance to share digital content with selected groups of individuals over the Internet. However, these dedicated servers are often costly and intimidating to the average consumer, especially to the computer novice. Most importantly, all of these local web servers lack the appeal of a printed book, conventional photo album, or binder, which help impart to the consumer a true sense of ownership of the printed images or records stored therein.

In the area of consumer electronic products, there continues to be a need for a simple, secure, affordable, and portable server for storing and sharing multimedia content across a network that approximates the experience of owning a book, photo album, or binder.

### SUMMARY

In one aspect of the invention, a network server is provided. The server includes a computer configured to host a web site for sharing images posted to the web site across a network. The server also includes a housing having a first cover, a second cover, and a spine. The spine connects the first and second covers in the manner of a book. The computer is mounted to the housing, for example at one or more surfaces of the covers or the spine, to provide the visual appearance of a book for the server.

In another aspect of the invention, a network server having the visual appearance of a book is provided. The server includes a computer configured to share multimedia content across a network. The server also includes a housing having a first cover, a second cover, and a spine. The spine connects the first and second cover. The computer is mounted to the housing, for example at one or more surfaces of the covers or the spine.

In yet another aspect of the invention, the network server includes a computer having web server software. The server also includes a housing having a first cover, a second cover, and a spine connecting the first and second cover in the manner of a book. The computer is mounted to the housing, for example at one or more surfaces of the covers or the spine, to provide the visual appearance of a book for the server.

### BRIEF DESCRIPTION OF THE DRAWINGS

FIG. 1 is a perspective view of a portable network server in accordance with the present invention;

FIG. 2 is another perspective view of the server of FIG. 1;

FIG. 3 is a is a block diagram of a computer of the server of FIG. 1;

FIG. 4 is an exploded view of the server of the server of FIG. 1;

FIG. 5 is another exploded view showing simulated pages for the server of FIG. 1;

FIG. 6 is a schematic diagram showing an operating system and application programs executing on the server of FIG. 1;

FIG. 7 is a schematic diagram of a network architecture using the server of FIG. 1; and

FIG. 8 is a schematic diagram of another network architecture using the server of FIG. 1.

### DETAILED DESCRIPTION OF THE PREFERRED EMBODIMENTS

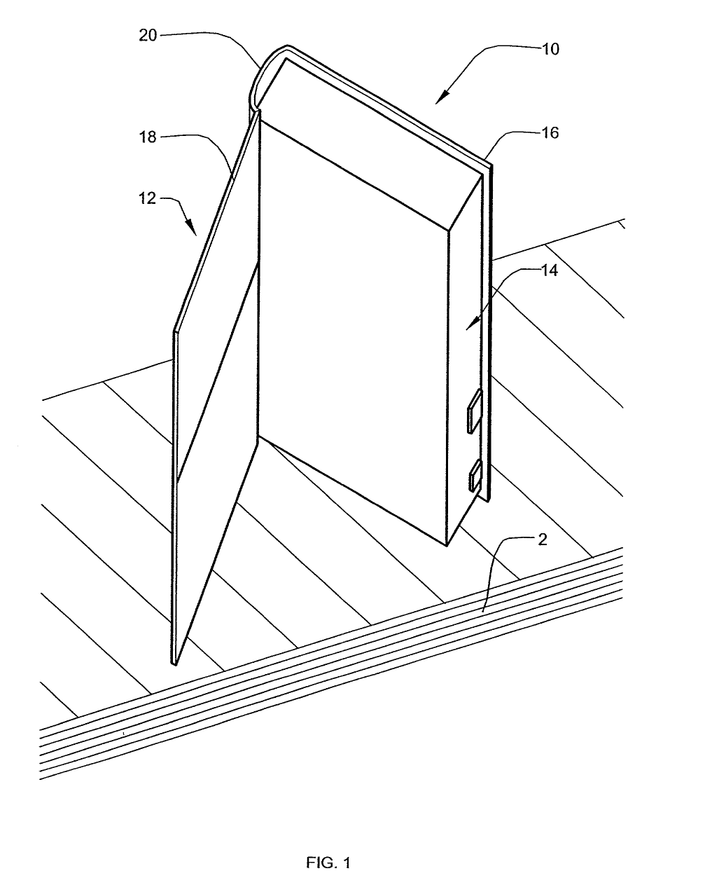

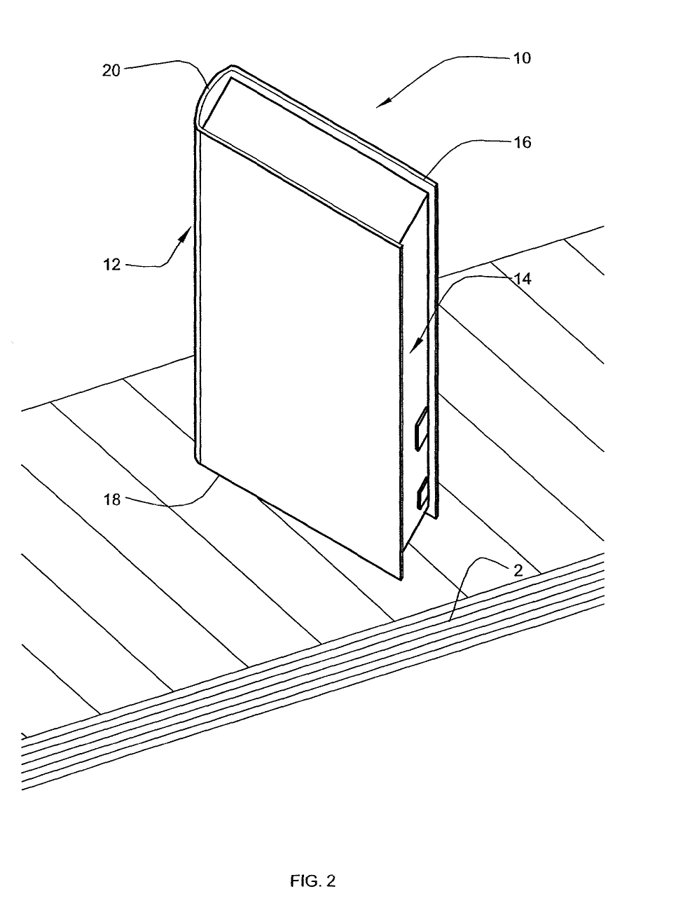

Referring now to the drawings and initially to FIGS. 1 and 2, a portable network server for storing, transporting, and sharing multimedia content over a computer network, according to the present invention, is indicated generally at 10 resting upright on a resting surface 2. The server 10 has an open position shown generally in FIG. 1 and a closed position shown generally in FIG. 2.

The server 10 includes a housing 12 and a computer 14. The housing 12 further includes a first cover 16 and a second cover 18, which are connected by a spine 20 in the manner of a book. Preferably, the covers 16 and 18 and the spine 20 also have a laminated construction for the housing 12 to resemble the appearance of a book.

In the embodiment shown in FIGS. 1 and 2, for example, the covers 16 and 18 and the spine 20 have a laminated construction for the housing 12 to resemble the appearance of a photo album. This construction includes a base-supporting layer of relatively rigid material, such as cardboard or plastic, covered by an outer layer of decorative vinyl material or other synthetic resinous material to resemble the appearance of a leather-bound photo album. Also, a layer of synthetic foam material could be sandwiched between the base-supporting cardboard layer and the decorative outer layer to maintain the feel of a leather-bound photo album. In addition, the inner surface of the base-supporting layer could be covered with at least one layer of vinyl, paper, fabric, or any other type of material suitable for a printed photo album cover.

However, it should be understood that other types of laminated construction for the covers 16 and 18 and the spine 20 could be used for the housing 12 to resemble, for example, the appearance of a metal, wood, or fabric covered photo album. Moreover, those skilled in the art will recognize that the housing 12 could be representative of other types of books, including but not limited to binders for keeping different types of records, such as tax records, medical records, etc.

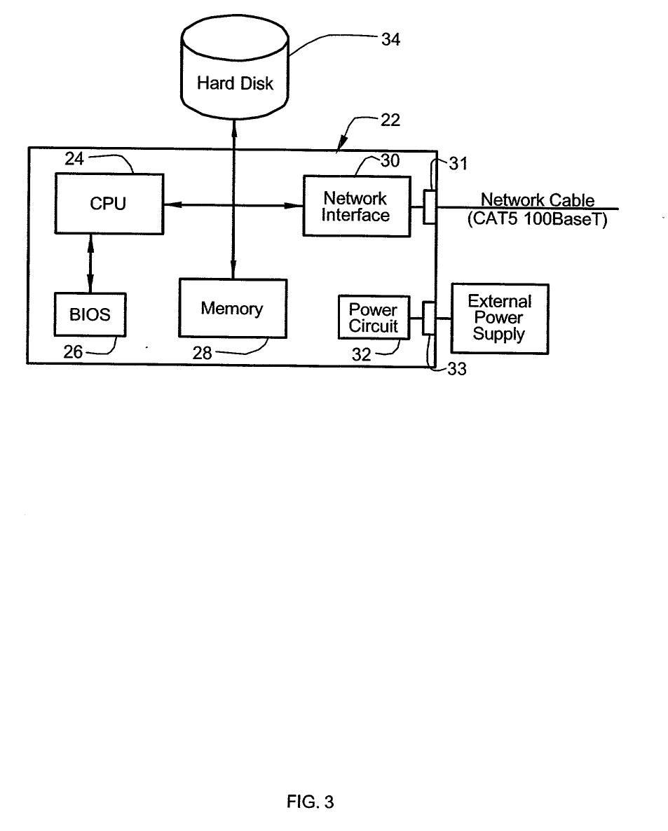

The computer 14 is generally illustrated at FIG. 3. It should be understood that this diagram is merely an illustration and should not limit the scope of the claims herein. The computer 14 includes a processor or CPU 24 capable of operating a web server, including but not limited to a StrongARM, ×86, or Pentium™ microprocessor from Intel, a K-6, Duron™, or Athlon™ microprocessor from AMD, or the Power PC™ processor from IBM. In addition, the computer 14 includes a BIOS 26, memory storage 28, for example random access memory (RAM), and an integrated network interface 30 for connecting to a network, such as an Ethernet network, via a network port 31. The Ethernet network contemplated is a type of communication network that complies with IEEE 802.3 networking standard, but the invention could use other types of networking standards. The computer 14 also includes a power circuit 32 for receiving electrical power from an external power supply via a power connector 33.

Preferably, the CPU 24, BIOS 26, memory 28, network interface 30, network port 31, power circuit 32, and power connector 33 are located onboard a single board computer (SBC) 22, for example a GE8010 PC/104 CPU Module manufactured by Global America Inc. of New Hampshire, USA, equipped with an Intel Pentium™ 266 MHz CPU, up to 128 MB SDRAM SODIMM Memory Module, an EIDE-PCI hard disk interface and a 10/100 MB Ethernet network interface.

The computer 14 also has a hard disk 34. Preferably, the hard disk 34 could be any IDE type hard disk having a capacity sufficiently large to store a library of multimedia content, for example 20 GB or greater. It will be understood by those skilled in the art that other suitable types of hard disk could be used to store multimedia content. In the embodiment shown in FIG. 3, the hard disk 34 is physically separate from the SBC 22. The hard disk 34 is connected to an integrated hard disk interface (not shown) on the SBC 22 for communication therewith via a ribbon cable or connector (not shown) conforming to the IDE standard.

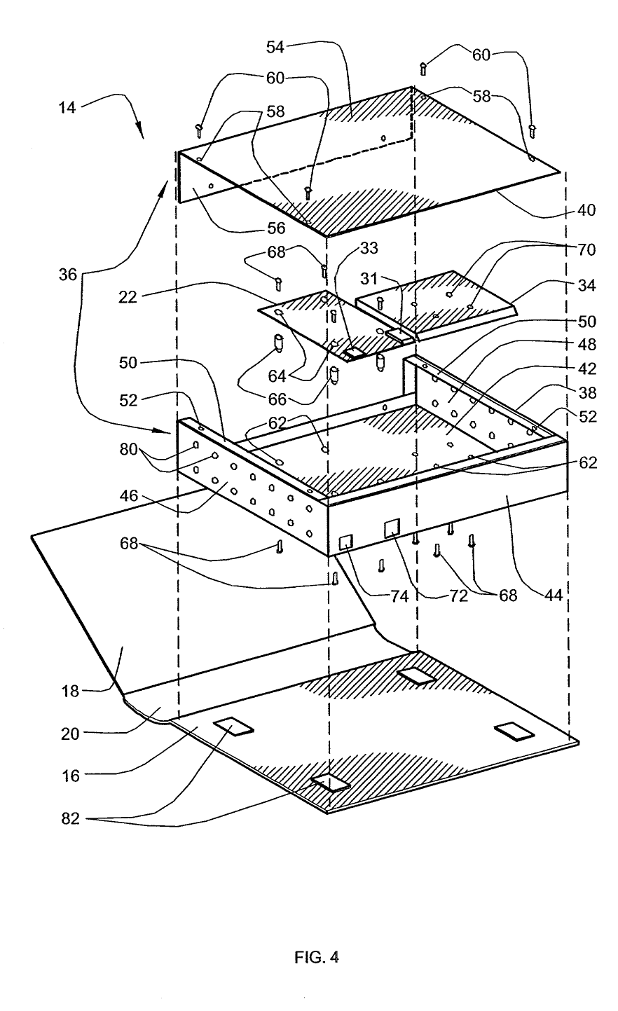

Referring next to FIG. 4, the computer 14 also includes a protective enclosure 36 for receiving and shielding the other components thereof, including the hard disk 34 and the SBC 22 having onboard the CPU 24, BIOS 26, memory 28, network interface 30, network port 31, power circuit 32, and power connector 33. Preferably, the protective enclosure 36 is an approximately rectangular box having overall dimensions generally less than the first cover 16 of the housing 12. The protective enclosure 36 is formed from sheet metal, although those skilled in the art will recognize that other suitable materials such as aluminum could be used.

The protective enclosure 36 has a frame portion 38 and a top portion 40. The frame portion 38 includes a base panel 42 and a first side panel 44, second side panel 46 and third side panel 48. The side panels 44, 46, and 48 are formed integrally with the base panel 42. The base panel 42 and side panels 44, 46, and 48 have retention flanges 50 that define a plurality of threaded receiving holes 52.

The top portion 40 includes a cover panel 54 and a fourth side panel 56 integral with the cover panel. The cover panel 54 and fourth side panel 56 define a plurality of receiving holes 58 that correspond to the threaded receiving holes 52 defined by the flanges 50. The top portion 40 is attached to the frame portion 38 using frame screws 60 inserted through the receiving holes 58 and secured within the threaded receiving holes 52. It should be understood by those skilled in the art that the protective enclosure 36 could have other configurations suitable for receiving and shielding the other components of the computer 14. For example, the frame portion 38 could include the base panel 42 and the four side panels 44, 46, 48 and 56, while the top portion 40 includes the cover panel 54.

The SBC 22 and hard disk 34 must be secured to the protective enclosure 36 to prevent against undesired movement. Preferably the outer surface of the base panel 42 defines a plurality of countersink holes 62 drilled through the base panel for attaching the SBC 22 and hard disk 34. In addition, the SBC 22 defines a plurality of corresponding mounting holes 64 drilled though the SBC. In order to securely attach the SBC 22 to the inner surface of the base panel 42, a plurality of spacers 66 are positioned between the SBC 22 and the inner surface of the base panel 42 at locations corresponding to the holes 62 and 64. The spacers 66 are formed from a rigid material, such as plastic or metal, and have suitable dimensions sufficient to prevent contact between the SBC 22 and the base panel 42, for example a length of about ¼ inch. Each spacer 66 includes opposing hollow threaded ends, which are secured to the SBC 22 and the base panel 42 using mounting screws 68 inserted through the holes 62 and 64. The mounting screws 68 are positioned in the countersink holes 62 such that the heads of the screws are recessed within the base panel 42.

Similarly, the hard disk 34 defines a plurality of threaded mounting holes 70 corresponding to base panel countersink holes 62 for attaching the hard disk 34 to the inner surface of the base panel 42. Mounting screws 68 are positioned in the countersink holes 62 such that the screws 68 are secured within the corresponding threaded mounting holes 70 of the hard disk 34 and the heads of the screws 68 are recessed within the base panel 42. The hard disk 34 is mounted proximate to the SBC 22 on the inner surface of the base panel 42 in order to minimize the footprint of the protective enclosure 36 and the computer 14.

In addition, the first side panel 44 defines a network port opening 72 and a power connector opening 74 for providing access to the network port 31 and power connector 33 respectively. In addition, the side panels 46 and 48 define a plurality of ventilation holes 80. Preferably, the ventilation holes 80 are spaced evenly across side panels 46 and 48 to allow for convection air flow through the protective enclosure 36. The distance between any two adjacent ventilation holes 80 is generally no less that about twice the diameter of a ventilation hole.

In order for the server 10 to be representative of a photo album, the computer 14 is mounted to the housing 12, as shown in FIG. 4. Preferably, the protective enclosure 36 of the computer 14 is mounted to the inner surface of the first cover 16 of the housing 12 using a plurality of adhesive tape portions 82. This allows the housing 12 to support the computer 14 when the server 10 is positioned upright. For example, a double coated polyethylene foam tape manufactured by Minnesota Mining and Manufacturing Company (commonly known as 3M) with a closed cell polyethylene foam carrier having a density of about 4 to 6 pounds/cubic foot and an acrylic of rubber adhesive could be used. The protective enclosure 36 of the computer 14 preferably is mounted approximately in the center of the first cover 16 such that when the server 10 is positioned upright on a resting surface 2, as shown in FIGS. 1 and 2, there exists a gap of at least about a ¼ inch between the protective enclosure 36 and the resting surface 2. This arrangement permits adequate airflow through the ventilation holes 80 for the ventilation of the computer 14 when the server 10 is positioned upright. When the first cover 16 having the computer 14 mounted thereto and the second cover 18 are closed, as shown in FIG. 2, the server 10 has the appearance of a photo album. Those skilled in the art will recognize that other suitable arrangements for mounting the protective enclosure 36 of the computer 14 to the inner surface of the first cover 16 could be used, including arrangements using glue or screws to mount one or more portions of the enclosure 36 or portions of the computer 14 to one or more surfaces of the housing 12.

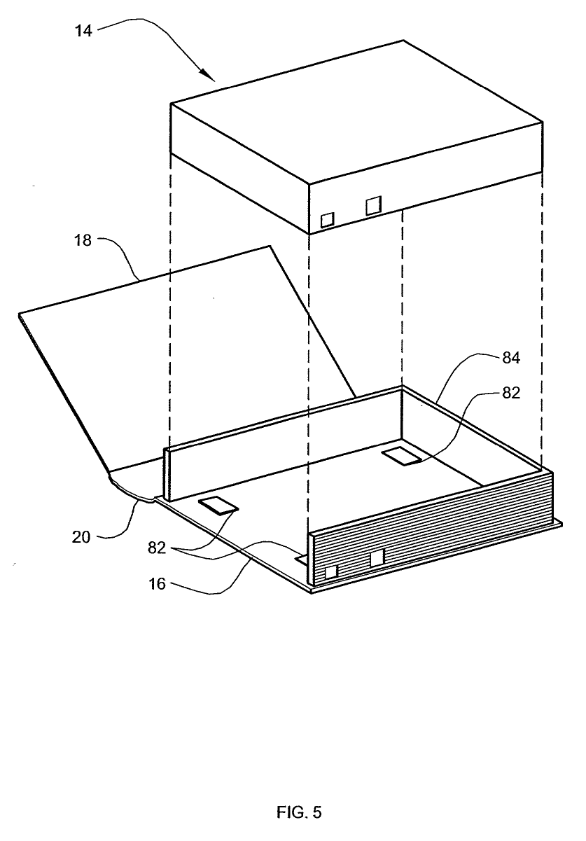

Referring next to FIG. 5, in an alternate embodiment, the server 10 includes a shell 84 having an outer surface that resembles the ridges of pages of a closed book. The shell 84 is formed from injection-molded foam or other appropriate plastic materials. Preferably, the shell 84 includes three panels having a U-shaped construction with overall dimensions slightly larger that the protective enclosure 36, such that the shell 84 is capable of receiving the protective enclosure therein as shown in FIG. 5. The shell 84 also defines a shell network port opening and a shell power connector opening for providing access to the network port 31 and power connector 33 respectively and a plurality of shell ventilation holes corresponding to the ventilation holes 80. The shell 84 is attached to the first cover 16 of the housing 12, for example using glue or adhesive tape. The computer 14 is mounted to the cover 16 as described above such that side panels 44, 46, and 48 of the frame portion 38 are substantially hidden from view by the shell 84.

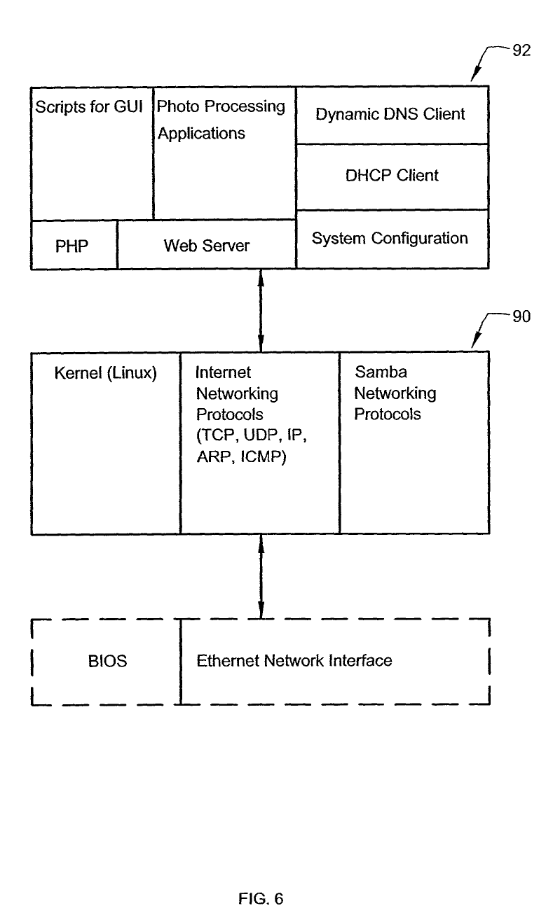

In order to share multimedia stored on the server across a network, the server 10 further includes an operating system 90 and at least one application program 92, as shown in FIG. 6.

The operating system 90 includes one or more programs that control the operation of the computer and manage the allocation of resources. The application program 92 includes one or more software programs that perform a task desired by the user. In the embodiment shown in FIG. 6, the operating system 90 includes the Linux operating system. Those skilled in the art will recognize that other operating systems compatible with the CPU 24 could be used, including but not limited or restricted to FreeBSD, QNX, Windows 98™, Windows 2000™, or Windows NT™.

In addition, the application program 92 preferably includes web server software, for example the public domain Apache web server software, which enables the server to deliver web pages. The application program 92 also includes digital image processing applications that allow for manipulation and viewing of digital images or other multimedia authoring software applications. The application program 92 further includes networking software for configuring the server on a network using a network address, for example a dynamic DNS client and DHCP client software.

In operation, a portable network server, according to the present invention, having the appearance of a photo album conveniently sits on a desktop or shelf, where it occupies minimal space. A user can simply connect the server to a computer network in order to share multimedia content stored thereon over the network, including text, graphics, video, animation, and sound. The user also can easily transport the server to a different physical location where it can be connected to another network.

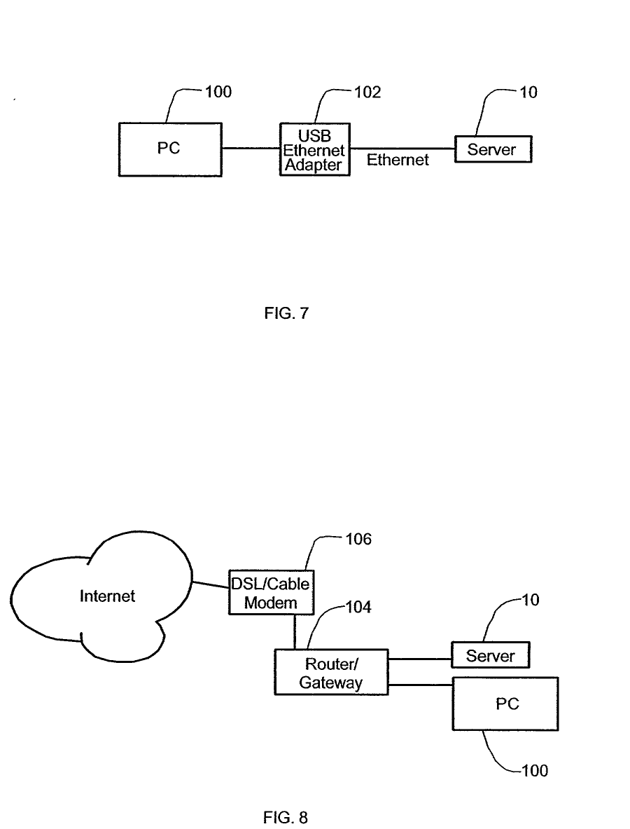

FIG. 7 illustrates a possible network architecture using a portable network server 10, according to the present invention, such that a local area network is created with a minimal number of components necessary for accessing the server. The 2-node network illustrated in FIG. 7 uses a universal serial bus (USB) Ethernet adapter 102 to connect a PC 100 to the server 10 using a cross-over Ethernet cable. A user can then configure the server 10 and publish images and other multimedia to its website using a web browser running on the PC 100.

Alternatively, FIG. 8 illustrates a network architecture that uses a portable network server 10, according to the present invention, to share multimedia content over a home network and over the Internet. The home network is a local area Ethernet network implementing the TCP/IP network protocol. The server 10 and a browser enabled PC 100 are connected to each other on the home network via a home router or gateway 104. Internet connectivity is provided via a DSL modem, cable modem, or other communication device 106, which is connected to the home router or gateway 104. Using a browser enabled PC 100 residing on the home network or the Internet, a user can remotely create and administer a personalized website that is hosted on the server 10. The user can publish multimedia content to the website from the PC 100 and display multimedia stored on the server 10 using the PC 100. The user can selectively grant or deny permission to other users to view multimedia stored on the server 10 via the server website and to post their content to the server website from a remote browser location. The user can select whether to physically connect the server 10 to the Internet or to keep it on the home network only. In this manner, a user can easily and safely share a library of digital images or other multimedia content stored on the server 10 with family and friends.

Although the invention has been described and illustrated with reference to specific illustrative embodiments thereof, it is not intended that the invention be limited to those illustrative embodiments. Those skilled in the art will recognize that variations and modifications can be made without departing from the true scope and spirit of the invention as defined by the claims that follow. It is therefore intended to include within the invention all such variations and modifications as fall within the scope of the appended claims and equivalents thereof.

I claim:

1. A network server comprising:
a computer configured to host a web site for sharing images posted to said web site across a network; and
a housing having a first cover, a second cover, and a spine connecting said first and said second cover in the manner of a book; wherein said computer is mounted to an inner surface of said housing to provide the visual appearance of said book for said server.

2. The network server of claim 1 wherein said book has the appearance of a photo album.

3. The network server of claim 1 wherein said book has the appearance of a binder.

4. The network server of claim 1 wherein said computer comprises a processor, a memory, a network interface, a power circuit, and a hard disk secured within a protective enclosure, said protective enclosure mounted to said inner surface of said housing.

5. The network server of claim 1 wherein said computer further comprises an operating system and at least one application program.

6. The network server of claim 1 wherein said server further comprises a shell having an outer surface that resembles pages of a closed book, said shell mounted to said inner surface of said housing for receiving said computer.

7. A network server having the visual appearance of a book comprising:
a computer configured to share multimedia content across a network; and
a housing having a first cover, a second cover, and a spine connecting said first and said second cover; wherein said computer is mounted to an inner surface of said housing.

8. The network server of claim 7 wherein said book has the appearance of a photo album.

9. The network server of claim 7 wherein said book has the appearance of a binder.

10. The network server of claim 7 wherein said computer comprises a processor, a memory, a network interface, a power circuit, and a hard disk secured within a protective enclosure, said protective enclosure mounted to said inner surface of said housing.

11. The network server of claim 7 wherein said computer further comprises an operating system and at least one application program.

12. The network server of claim 7 wherein said server further comprises a shell having an outer surface that resembles pages of a closed book, said shell mounted to said inner surface of said housing for receiving said computer.

13. A network server comprising:
a computer having web server software; and
a housing having a first cover, a second cover, and a spine connecting said first and said second cover in the manner of a book; wherein said computer is mounted to an inner surface of said housing to provide the visual appearance of said book for said server.

14. The network server of claim 13 wherein said book has the appearance of a photo album.

15. The network server of claim 13 wherein said book has the appearance of a binder.

16. The network server of claim 13 wherein said computer comprises a processor, a memory, a network interface, a power circuit, and a hard disk secured within a protective enclosure, said protective enclosure mounted to said inner surface of said housing.

17. The network server of claim 13 wherein said computer further comprises an operating system and at least one application program.

18. The network server of claim 13 wherein said server further comprises a shell having an outer surface that resembles pages of a closed book, said shell mounted to said inner surface of said housing for receiving said computer.
